(19) United States
(12) Patent Application Publication
(10) Pub. No.: US 2013/0097202 A1
(43) Pub. Date: Apr. 18, 2013

(54) Method and System for Providing Opinion Queries to Users

(71) Applicant: Radu Jurca, Adliswil (CH)

(72) Inventor: Radu Jurca, Adliswil (CH)

(73) Assignee: Google Inc., Mountain View, CA (US)

(21) Appl. No.: 13/272,104

(22) Filed: Oct. 12, 2011

(51) Int. Cl. G06F 17/30

(52) U.S. Cl. 707/780; 707/E17.014

(57) ABSTRACT

A system and machine-implemented method for displaying an opinion query to a user, the method including receiving a request for online content from a user, determining, using the one or more computing devices, one or more terms associated with the request, selecting, using the one or more computing devices, an opinion query based on the one or more terms from a database coupled to the one or more processors, wherein the opinion query includes a question and one or more possible responses for the question, providing the opinion query to be displayed to the user together with the online content corresponding to the request, receiving an indication of a selection of one of the one or more possible responses from the user and providing, using the one or more computing devices, the indication of the selection for storage and analysis in association with the opinion query.

### BACKGROUND

The subject disclosure generally relates to presenting opinion queries to users of electronic devices, and, in particular, to creating and presenting opinion queries to users in a targeted manner.

Targeted advertisements may be presented to a user when the user is interacting with online content. For example, when a user wishes to search for content on the internet, the user enters a search query including one or more search terms. In addition to using the search terms to provide the user with search results, a system may further use the search terms as keywords for providing targeted advertisements to the user, and thus generate revenue.

However, targeted advertisements may be limited to products and services associated with keywords corresponding to search terms. Therefore, where a search query is not related to actual products or services, the opportunity for providing targeted advertisements to users may become limited. Furthermore, while the ads allow marketing of existing products and services, the ads do not necessarily provide for obtaining user opinions relating to general concepts or future products in a targeted manner.

Thus, a method for creating and presenting opinion queries relating to a wide array of topics in a targeted manner may be desirable.

### SUMMARY

The disclosed subject matter relates to a method for execution on one or more computing devices for displaying an opinion query to a user, the method comprising receiving a request for online content from a user. The method further comprising determining, using the one or more computing devices, one or more terms associated with the request. The method further comprising selecting, using the one or more computing devices, an opinion query based on the one or more terms from a database coupled to the one or more processors, wherein the opinion query includes a question and one or more possible responses for the question. The method further comprising providing the opinion query to be displayed to the user together with the online content corresponding to the request. The method further comprising receiving an indication of a selection of one of the one or more possible responses from the user and providing, using the one or more computing devices, the indication of the selection for storage and analysis in association with the opinion query.

The disclosed subject matter also relates to a system for displaying an opinion query to a user, the system comprising one or more processors and a machine-readable medium comprising instructions stored therein, which when executed by the processors, cause the processors to perform operations comprising receiving an indication of a request from a user to view online content. The operations further comprising identifying one or more terms associated with the request in response to receiving the indication. The operations further comprising selecting an opinion query of one or more existing opinion queries based on the identified one or more terms, wherein the opinion query includes a question and one or more possible responses to the question. The operations further comprising providing the opinion query to be displayed to the user along with the online content corresponding to the request. The operations further comprising receiving an indication of a selection of one of the one or more possible responses from the user and providing the response for storage and analysis in association with the opinion query.

The disclosed subject matter also relates to a machine-readable medium comprising instructions stored therein, which when executed by a machine, cause the machine to perform operations comprising receiving one or more terms associated with a request for content from a user. The operations further comprising selecting one or more opinion queries in response to receiving the indication, each opinion query being associated with one or more keywords matching at least one of the one or more terms, wherein each of the one or more opinion queries includes a question and one or more possible responses to the question. The operations further comprising identifying user information associated with the user and comparing the user information and audience targeting information associated with the one or more opinion queries. The operations further comprising selecting an opinion query for display to the user based on the comparing. The operations further comprising receiving an indication of a selection of one of the one or more possible responses from the user and providing the response for storage and analysis in association with the opinion query.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for creating and targeting opinion queries to users.

FIG. 2 illustrates a flow chart of an example process for creating an opinion query campaign.

FIG. 3 illustrates a screen-shot of an example graphical user interface for signing into a system for creating and targeting opinion queries to users.

FIG. 4 illustrates a screen-shot of an example graphical user interface for creating a new campaign.

FIGS. 5A and 5B illustrate screen-shots of an example graphical user interface for defining an opinion query.

FIGS. 6A, 6B and 6C illustrate screen-shots of an example graphical user interface for defining audience target criteria for an opinion query campaign.

FIG. 7 illustrates a screen-shot of an example graphical user interface for reviewing an opinion query and entering budget and bid information for the opinion query campaign.

FIG. 8 illustrates a flow chart of an example process for providing an opinion query to a user in a targeted manner.

FIG. 9 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

The disclosed subject matter provides a system for allowing a marketer to create an opinion query, define targeting criteria and objectives with regard to the opinion query and to receive feedback regarding the opinion query. As used herein, the term “opinion query” encompasses its plain and ordinary meaning including, but not limited to, secondary content presented to a user in the form of a question and a number of responses to seek an opinion of the user (e.g., user interacting with online content) regarding a topic. The term “marketer,” as used herein encompasses its ordinary meaning including but not limited to any individual, company, organization or other entity interested in receiving an opinion from users regarding a topic.

A marketer provides an opinion query by specifying a question that the marketer wishes to have answered and selecting a number of possible responses to the question. It may be additionally possible to provide users with an opportunity to enter free form responses (e.g., a free form response may be defined as one possible variant). The topic of an opinion query may relate to any topic in regard to which a marketer may wish to receive opinion or feedback. For example, the opinion query may relate to an overall concept such as a philosophical or ethical issues or scientific concepts or to a specific line of products or services or to opinions regarding individuals, groups or organizations. Since the opinion query is not limited to products or services which an advertiser wishes to sell, the opinion query provides new opportunities for earning revenue by targeted presentation of the opinion query when a user is searching content that is not related to any specific products or services.

The system further facilitates providing opinion queries created by one or more marketers to users interacting with online content in a targeted manner. The marketer may design an opinion query including a question and two or more possible responses. In addition, the marketer may specify one or more keywords associated with the opinion query. Additionally, the marketer may provide various audience targeting criteria such as geographical location, demographic and context (e.g., language) for targeting the opinion query to specific users.

Once the opinion query is created, the marketer may specify a bid range for the opinion query (i.e., a minimum and maximum dollar amount the marketer is willing to pay per response), as well as a budget. Unlike advertisements where the bid price is based upon a “click through” rate, with respect to opinion queries, the bid price may be based on the user actually providing a response to the opinion query. Thus, the marketers are able to bid for receiving actual information from users. The budget may be expressed as a response target. Furthermore, the marketer may specify a budget for the opinion query. The budget may be used by the system to determine when to stop presenting the opinion query to new users (i.e., when the opinion query campaign has ended). The response target refers to the number of user responses that the marketer would like to receive. Additionally, the budget may be expressed as a dollar amount referring to the amount of money a marketer wants to spend on the opinion query campaign. The dollar amount provided determines the number of answers based on the bidding later performed when selecting and presenting the opinion query for display to a user.

The opinion query generated by the marketer may be added to a pool of possible promotional content, including advertisements, to be presented to a user when the user enters a search query including one or more search terms matching the keywords associated with the opinion query. For example, in one aspect, the system may maintain or have access to an opinion query database storing all opinion queries created by a user and an advertisement database storing all advertisements provided for provision to users. Alternatively, all promotional content may be stored within a single database or may be distributed among a number of databases.

The selection of possible promotional content may be performed in an auction, where upon detecting promotional content corresponding to the search terms entered by a user, a bidding process is performed, where the promotional content(s) with the highest bid and/or revenue generation potential is selected for being displayed to the user. One or more opinion queries may be selected and displayed to a user (e.g., within the graphical user interface displaying the search results). The user may view an opinion query and respond to the opinion query directly at the graphical user interface displaying the opinion query.

The response may be detected by the system and used to provide the marketer with various feedback data regarding the opinion query—either in response to the individual response or based on aggregate responses. The feedback data may include a distribution of responses, total number of responses, as well as a temporal or demographic split down of responses. The feedback may be periodically updated as additional responses are received from users. In addition to providing feedback data to marketers, the responses may be used by the system to update a user profile of the user, and use the data for targeting promotional content, including future opinion queries, to the user.

Thus, the system provides a new method of generating revenue by providing a mechanism for targeting opinion queries to a user of the system based on keywords. The system may further perform similar processes as described herein for providing targeted opinion queries to a user when the user is interacting with any online content (e.g., based on the keywords related to such online content). The opinion query may comprise a question related to the content or may seek opinion regarding the content itself (e.g., the quality of the content, the accuracy of the content or search results). The description herein with respect to a search query and search terms by a user is merely an example embodiment and does not limit the scope of operations of the system or processes described herein.

II. Example Client-Server Network Environment for Facilitating Creation and Targeted Distribution of an Opinion Query to Users

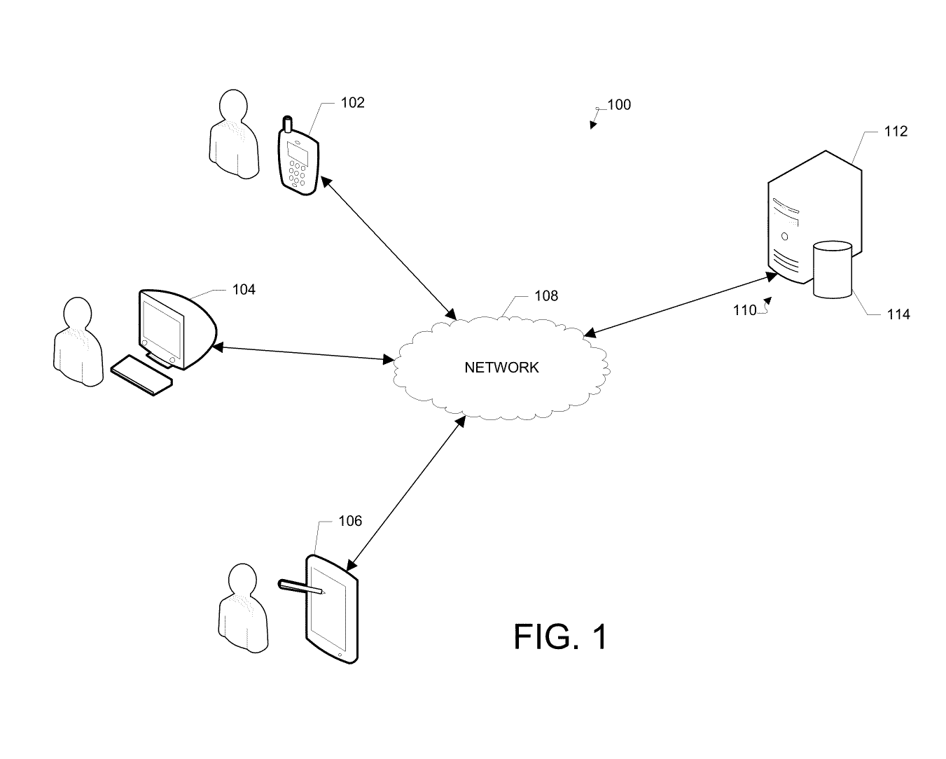

FIG. 1 illustrates an example client-server network environment which provides for creating and targeting opinion queries to users. A network environment 100 includes a number of electronic devices 102, 104 and 106 communicably connected to a server 110 by a network 108. Server 110 includes a processing device 112 and a data store 114. Processing device 112 executes computer instructions stored in data store 114, for example, to provide opinion queries to users interacting with electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices. In the example of FIG. 1, electronic device 102 is depicted as a smartphone, electronic device 104 is depicted as a desktop computer, and electronic device 106 is depicted as a PDA.

In some example aspects, server 110 can be a single computing device such as a computer server. In other embodiments, server 110 can represent more than one computing device working together to perform the actions of a server computer (e.g., cloud computing). Furthermore, network 108 can be a public communication network (e.g., the Internet, cellular data network, dialup modems over a telephone network) or a private communications network (e.g., private LAN, leased lines).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Example Process for Creating an Opinion Query

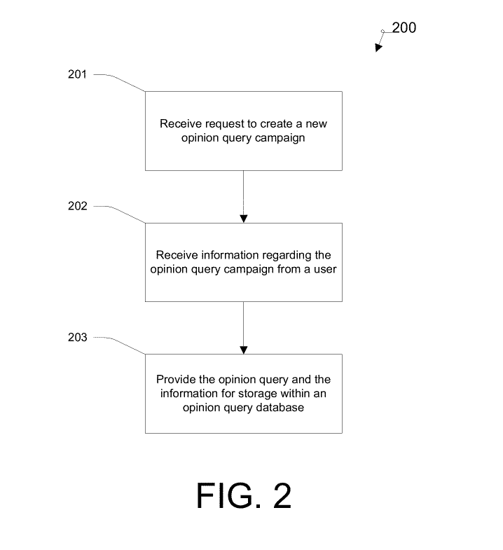

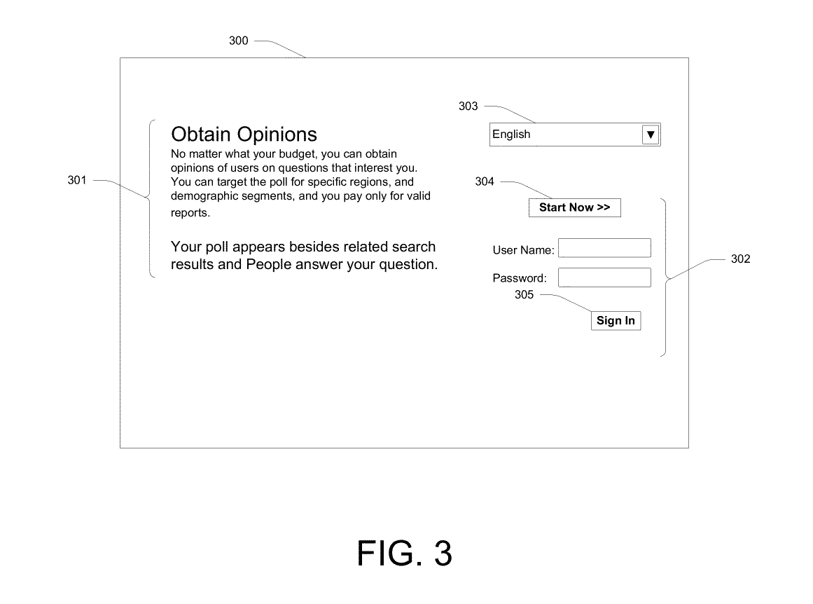

FIG. 2 illustrates a flow chart of an example process 200 for creating an opinion query campaign. In step 201, the system receives an indication of a request from a user (e.g., marketer) to create a new campaign. For example, the user may log into a client application at the user's client device and select to create a new opinion query campaign. The system receives the indication and may display a graphical user interface to the user for receiving information to create the opinion query campaign. FIGS. 3-6 display screen-shots of example graphical user interfaces that may be provided to the user for entering information regarding the campaign, and are described in more detail below.

In step 202, the system receives information regarding the campaign. The information may include a campaign name, where the ad will appear (e.g., specific websites and/or applications, networks, devices), audience targeting information such as geographic location, demographics, language (e.g., language that an opinion query will appear in and/or languages known by the target audience), budget information (e.g., number of answers requested and/or dollar amount, set for a period of time or overall), and a bid amount (e.g., maximum bid amount). Additionally, the information includes a question and response(s) for the opinion query. Furthermore, the information may include keywords including potential words or phrases related to the campaign that describe the opinion query campaign and/or trigger the opinion query being considered for presentation to the user (e.g., search terms or phrases a user would enter as search terms). The information may be entered at the graphical user interface presented to the user at a client device (e.g., electronic devices 102, 104 and 106). The information may be received at the client device and transmitted to the system (e.g., at server 110), through network 108. In step 203, the system generates an opinion query campaign according to the information and may provide the generated opinion query campaign (i.e. the opinion query and information associated with the opinion query) for storage within a database (e.g., the opinion query database).

IV. Example User Interface for Creating an Opinion Query

FIG. 3 illustrates a screen-shot of an example graphical user interface for signing into a system for creating and targeting opinion queries to users. Each user (e.g., marketer) may have a unique account including a user name and password and may sign into the system using his/her account information. The user (e.g., marketer) may access the system from a browser or client application running on the client device of the user (e.g., electronic devices 102, 104 or 106). Communication between client devices and the system may be facilitated through a network (e.g., network 108). In one aspect, upon receiving a user request to interact with the system at a client device (e.g., electronic devices 102-106), the client device may initiate a communication with the system.

Upon accessing the system, the user may be presented with the graphical user interface of FIG. 3 including a welcome message 301 providing the user with a brief description of the services provided by the system and a sign in area 302, where the user enters his/her user name and password. Furthermore, the welcome window 300 may include a language selection menu, allowing the user to select a language, where the system will present the services (e.g., creation and management of opinion query campaigns) to the user in the selected language.

If this is the first time a user interacting with the system, the user may not have an existing account, thus, the user may select the “Start now” button 304 to create a new account for signing into the system. Otherwise, the user viewing the graphical user interface of FIG. 3 may enter his/her account information and select the “sign in” button 305. The client device may then send a data set including the account information of the user to the system (e.g., at server 110). The data set can be transmitted from the user's client device (e.g., electronic devices 102-106) and received at server 110 hosting the system, for user authentication. Once the user is authenticated and access is granted to the user, the system may retrieve and send a data set to the user's client device, for displaying a graphical user interface at the client device for creating a new campaign or managing an existing campaign (e.g., modify opinion query information relating to the campaign), viewing reports and analytics regarding an existing campaigns and/or managing the user's account information.

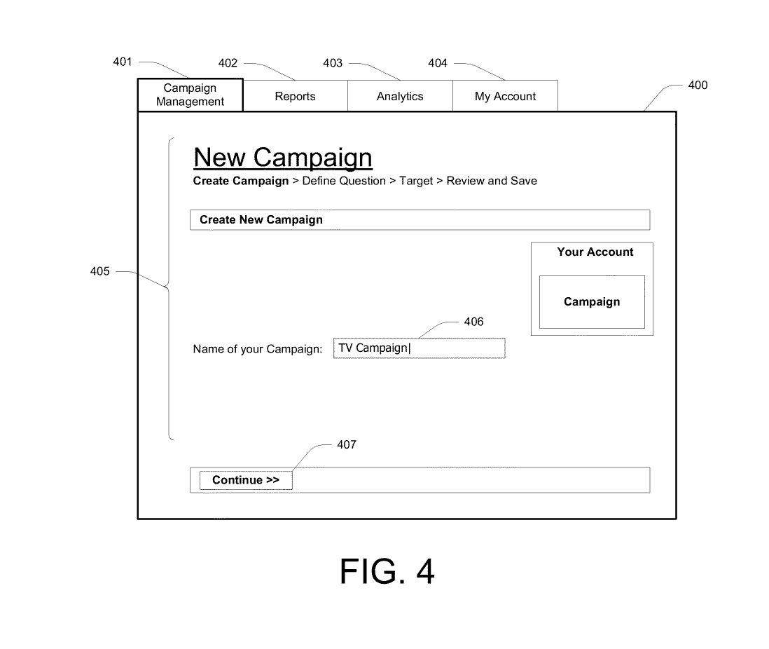

FIG. 4 illustrates a screen-shot of an example graphical user interface for creating a new campaign. The graphical user interface displayed to the user upon entering the system includes an account window 400 having multiple tabs including “campaign management” tab 401, “reports” tab 402, “analytics” tab 403, and “my account” tab 404. The user wishing to create a new opinion query campaign may select the campaign management tab (or alternatively the client application may be defaulted to the tab 401 upon signing the user into the client application). Upon selecting to create a new campaign, the graphical user interface requests that the user enter a name for the new campaign (e.g., within the “campaign name” field 406). The user may enter a name for the opinion query campaign within the campaign name field 406 and selects the “continue” button 407 to continue to the next step for creating a new opinion query campaign. The continue button will cause the graphical user interface to be updated to display the next step in the process of creating a campaign by defining the opinion query.

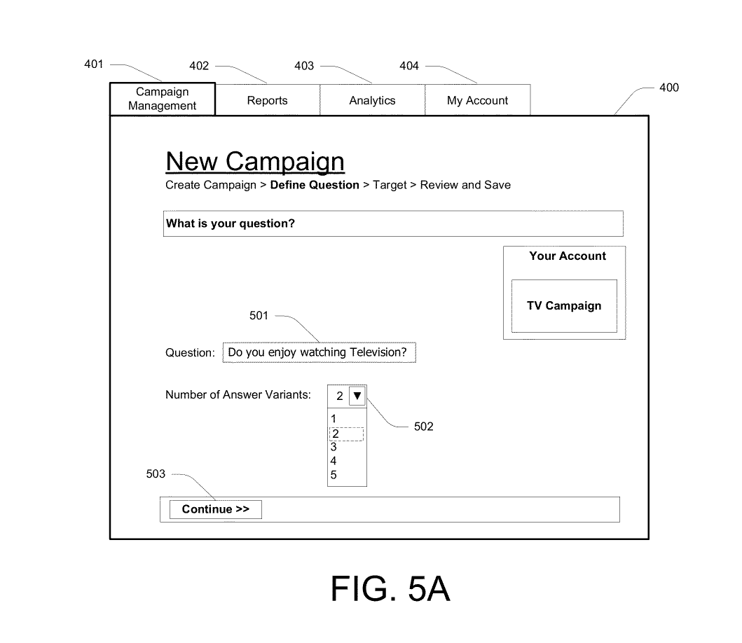

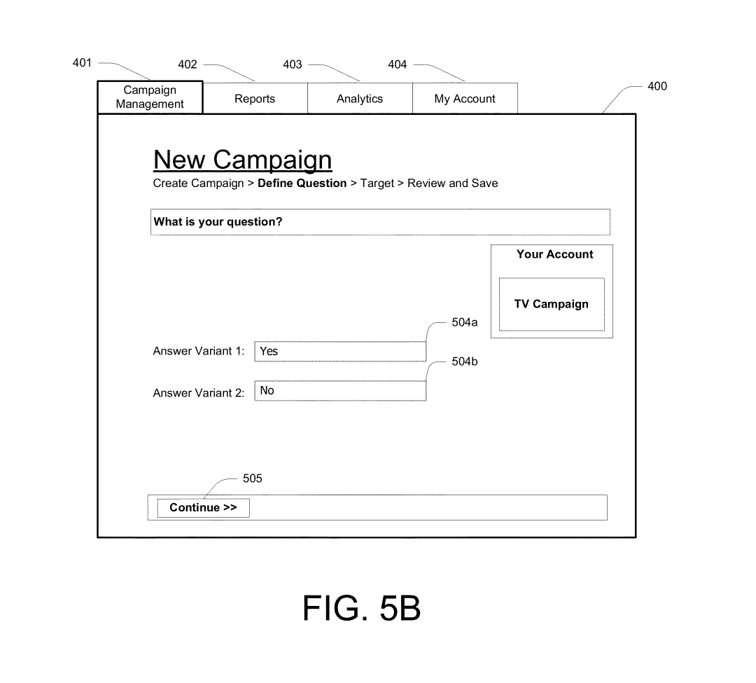

FIGS. 5A and 5B illustrate screen-shots of an example graphical user interface for defining an opinion query. The opinion query includes a question and one or more possible responses. The graphical user interface of FIG. 5A displays a “question field” 501 for entering the question for the opinion query. Furthermore, a “variant selection” menu 502 is displayed for selecting the number of variants (i.e., responses) for the specific opinion query. The variant selection menu 502 may be presented as a drop down menu with choices for the possible numbers of variants. Alternatively, the variant selection menu may be replaced by a text entry field where the user may enter the number of variants. Once the user has entered the question and selected the number of variants for the opinion query, the user may select the “continue” button 503, and the graphical user interface may be updated to present the graphical user interface of FIG. 5B, allowing the user to enter values for each variant of the opinion query. In this example embodiment, the user has selected two variants for the opinion query, and thus the graphical user interface of FIG. 5B displays two variant entry fields 504a and 504b for entering the responses for the question entered within the question entry field 502 of the graphical user interface of FIG. 5A. Upon entering the desired responses for the opinion query, the user may select the continue button 505 to advance to the next step in the campaign creation process.

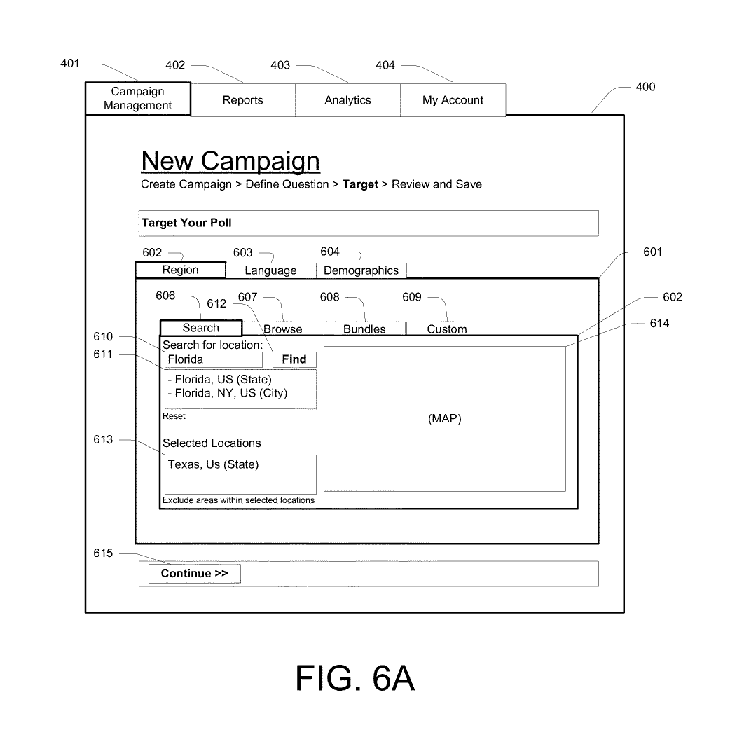

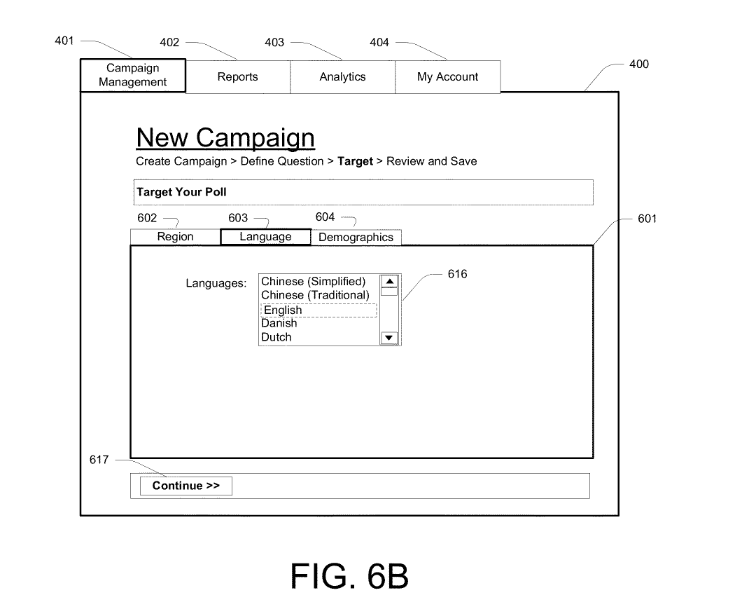

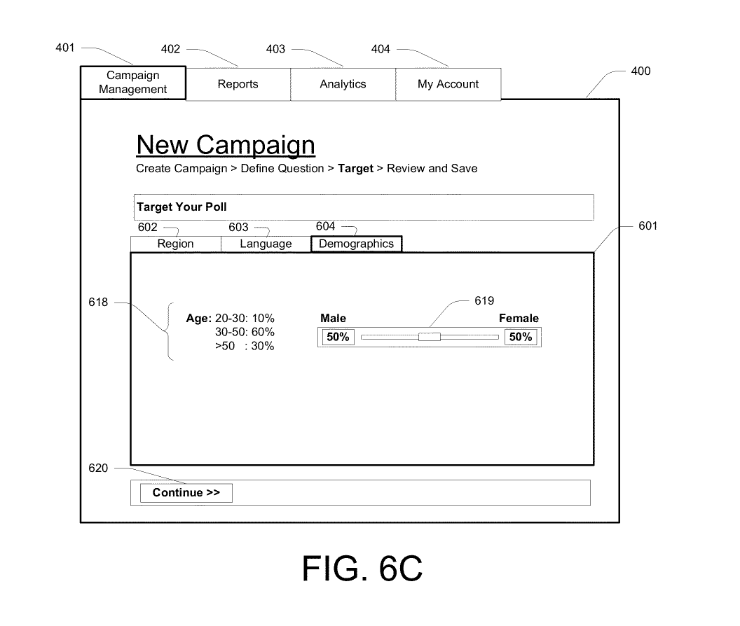

FIGS. 6A, 6B and 6C illustrate screen-shots of an example graphical user interface for defining audience target criteria for an opinion query campaign. The graphical user interface for defining audience target criteria displays an “audience target” window 601 having tabs for each type of criteria that may be defined for targeting the opinion campaign to specific audience. For example, as illustrated in FIGS. 6A-C, the tabs may include a “region” tab 602, a “language” tab 603 and a “demographics” tab 604. The region tab 601 provides the user with a location window 605 having various tabs including a “search” tab 606, a “browse” tab 607, a “bundles” tab 608, and a “custom” tab 609, for selecting locations for targeting the opinion query to audience within specific locations.

The tabs 606-609 allow the user to select locations using different techniques. For example, as illustrated, the search tab 606 displays a “search entry” field 610 for entering part or all of a location name. The user upon entering a search term (e.g., name of desired location) may select the “find” button 612 to receive suggested locations. A “results suggestion” box 611 displays suggested search results based on the search term and the user may select one or more of the suggested locations. A “selected locations” box 613 displays all locations already selected by the user. A map area 614 may further display a map of the suggested locations and/or selected locations to the user. The browse tab 607, the bundle tab 608, and the custom tab 609 provide other ways for entering desired locations for targeting the opinion query. Once the user has selected all desired locations, the user may select the continue button 615 to continue to the next step for defining audience target criteria. Alternatively, the user may simply select the “languages” tab 603 or “demographics” tab 604 and enter desired audience targeting criteria.

FIG. 6B displays a screen-shot of the user interface for selecting desired languages for targeting the opinion query. A “languages” menu 616 is displayed to the user (e.g., as a drop down menu) within the languages tab 603, and the user may select one or more languages for targeting the opinion query to specific audience speaking those language or interacting with online content written in those languages. Once the user has selected one or more desired language for targeting the opinion query, the user may press the continue button 617, and the graphical user interface may be update to display the demographics tab, as displayed in the graphical user interface of FIG. 6C.

The demographics tab 604 may include one or more selectors for entering various demographics information regarding the desired audience for the campaign. For example, the user may select an age range for the audience (as displayed within the target age section 617) and may further select a gender breakdown using a selector 619. Various other demographic break downs may be selectable by the user. Once the user has entered the desired demographic information, the user may select the continue button 620 to advance to the next stage within the campaign creation process.

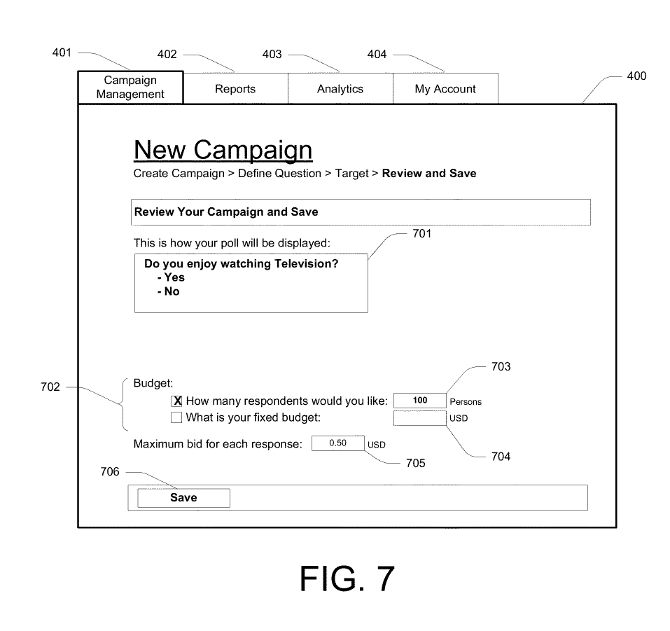

FIG. 7 illustrates a screen-shot of an example graphical user interface for reviewing the opinion query and entering budget and bid information for an opinion query campaign. The graphical user interface of FIG. 7 illustrates an “opinion query display” box 701, displaying the opinion query (e.g., the question and responses) to the user, such that the user can review how the opinion query will be displayed to the target audience. Furthermore, a “budget selection” area 702 is displayed to the user for selecting the desired budget for the opinion query campaign. The desired budget may be expressed in terms of the number of responses desired, and may be entered within the entry box 703, or as a total dollar amount and entered within the entry box 704. A user may select the mode for specifying a budget using selection boxes provided next to each of the two options. In addition, the user is further able to enter bid amount data including for example a maximum bid amount for each response within the bid entry box 705. The user is able to bid for actual responses received, unlike advertisements where the bidding is on a per-click basis. Thus, both the user's budget and bid amount are focused on actual responses rather than a click-through.

Once the user has entered all desired information within the graphical user interface of FIG. 7, the user may then select the “save” button 706 to complete the process of creating an opinion query campaign. The user may also access reports, analytics and edit account or campaign information using the graphical user interface of the user account, for example by selecting the reports tab 402, the analytics tab 403 and my account tab 404, respectively. Furthermore, once the user has created an opinion query campaign, the user may select to modify the opinion query by logging into his/her account (e.g., within the campaign management tab 401).

Once the opinion query campaign is completed, or alternatively during the campaign creation process, the user may further select keywords (e.g., through a graphical user interface) used for targeting the opinion query to users. Keywords may also be selected by the system based on the question and responses entered by the user (e.g., words within the question and response, or words related to the question and response). The selected keywords may include words and/or phrases that will trigger selecting the opinion query for presentation to an audience (e.g., users interacting with online content). For example, keywords may include words and/or phrases a user would use as search terms or words or phrases that may appear within various applications or within website content. The keywords are likely to be terms related to the subject or topic of the opinion query and may include a range of broad and/or specific terms or phrases.

The opinion query campaign, including the opinion query and information provided by the user, and the associated keywords may then be stored within a database for later retrieval and presentation for display to a user at a website (e.g., along with search results where the user is searching for various topics, products or services).

V. Example Process for Displaying an Opinion Query in a Targeted Manner

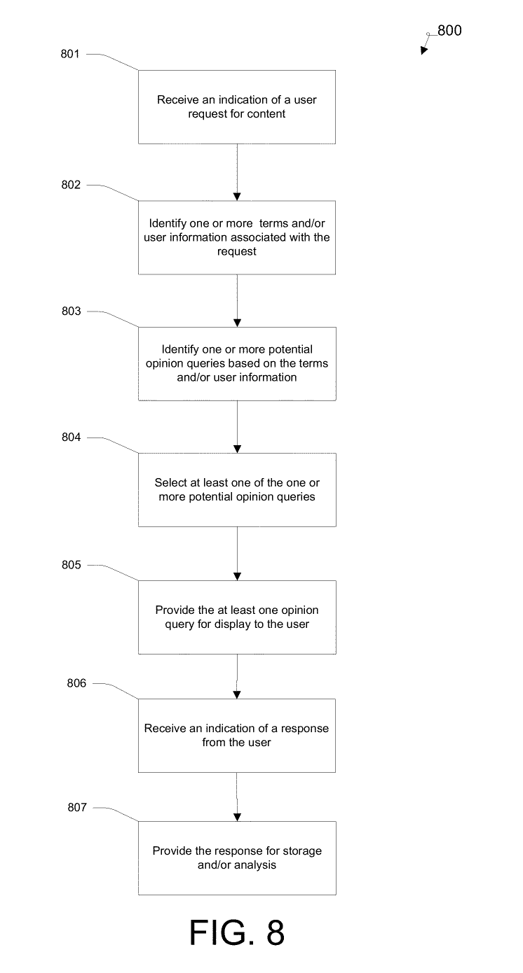

FIG. 8 illustrates a flow chart of an example process 800 for providing an opinion query to a user in a targeted manner. In step 801, the system receives an indication of a user request for content (e.g., online content). The request may be entered by a user interacting with a website or client application. The request for content may comprise a search request, or a request to access a website page (e.g., by typing in a URL) or to launch an application. For example, the system may receive an indication of a user search request according to one or more search terms. For example, a user may enter a word or phrase within a text search box to receive information regarding the entered word or phrase. Alternatively, in step 701, the system may receive an indication of a user interacting with a software client application or website (e.g., requesting to access the website or launch the application).

In step 802, the system identifies one or more user characteristics and/or one or more terms relating to the user's request for content and/or interaction with the website or software client application (e.g., search terms or terms related to website or application content requested by the user). In step 803, the system may identify one or more potential opinion queries based on the identified one or more terms. For example, in step 803, the system may access a database (e.g., opinion query database) storing one or more existing opinion queries and information associated with the opinion queries (e.g., as an opinion query campaign). The system may compare the keywords associated with each of the opinion queries against the terms identified in step 802. Additionally, the system may compare the audience target information (e.g., location, demographics and language) associated with each of the opinion queries against the user information identified in step 802. Based on the comparison, the system selects one or more potential opinion queries.

In step 804, the system selects at least one of the one or more potential opinion queries for provision to the user along with the content requested by the user (e.g., along with the search results or at the website or client application). For example, once the system has identified the potential opinion queries, the system proceeds to an auction process to select at least one of the one or more potential opinion queries. The auction may be between the one or more potential opinion queries and may further include one or more potential advertisements. Using the bid information (e.g., maximum bid) for each of the potential opinion queries the system may then conduct an auction to select at least one opinion query. In addition to bidding, the selection process may further include determining a quality score for each potential opinion query. The quality score may be calculated based upon the user characteristics, history and/or the content the user is requesting (e.g., the search results, website content or client application content). The quality score may indicate the potential for each of the opinion queries to generate revenue. For example, the quality score may indicate the likelihood of the user actually responding to the opinion query once it is displayed. Based upon the auctioning process and/or the quality score, the system then selects the opinion query in step 804.

Next, in step 805, the system provides the selected at least one opinion query for provision to the user. The opinion query may be displayed to the user along with the requested information (e.g., along with the search results or at the website or client application). More than one opinion query of the one or more potential queries may be selected and provided for display. In one embodiment, the process may end in step 805, after the system has provided the selected opinion query for display to the user.

Alternatively, the process may continue to step 806 when the system receives an indication of the user selecting the opinion query and responding to the question. In step 807, the response is provided for storage and/or analysis. For example, the system may store the response along with all responses relating to the opinion query for creating various feedback data (e.g., reports and analytics) relating to the opinion query and/or the opinion query campaign. The feedback data may include analysis regarding the results of the opinion query (e.g., according to the responses received from the users) and/or the overall quality of the opinion query (e.g., the percentage of the selection and response of the opinion query when the opinion query is displayed). The feedback data may include a distribution of responses, total number of responses, as well as a temporal or demographic split down of responses. The feedback may be periodically updated as additional responses are received from users. In addition to providing feedback data to marketers, the responses may be used by the system to update a user profile of the user responding to the opinion query (e.g., for future use when targeting promotional content, including future opinion queries, to the user).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

VI. Example System for Creating and Displaying an Opinion Query in a Targeted Manner

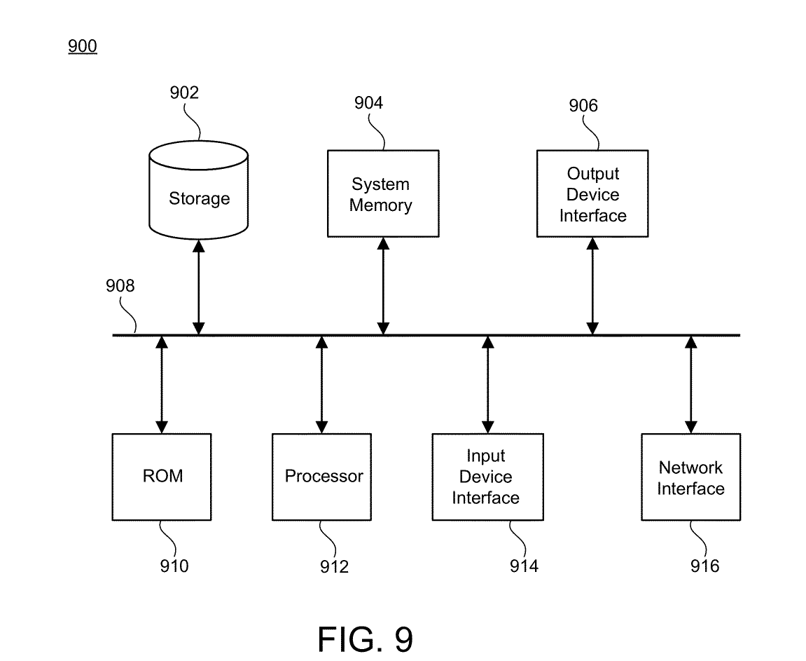

FIG. 9 conceptually illustrates an electronic system with which some implementations of the subject technology are implemented. Electronic system 900 can be a server, computer, phone, PDA, or any other sort of electronic device. Such an electronic system includes various types of computer readable media and interfaces for various other types of computer readable media. Electronic system 900 includes a bus 908, processing unit(s) 912, a system memory 904, a read-only memory (ROM) 910, a permanent storage device 902, an input device interface 914, an output device interface 906, and a network interface 916.

Bus 908 collectively represents all system, peripheral, and chipset buses that communicatively connect the numerous internal devices of electronic system 900. For instance, bus 908 communicatively connects processing unit(s) 912 with ROM 910, system memory 904, and permanent storage device 902.

From these various memory units, processing unit(s) 912 retrieves instructions to execute and data to process in order to execute the processes of the subject disclosure. The processing unit(s) can be a single processor or a multi-core processor in different implementations.

ROM 910 stores static data and instructions that are needed by processing unit(s) 912 and other modules of the electronic system. Permanent storage device 902, on the other hand, is a read-and-write memory device. This device is a non-volatile memory unit that stores instructions and data even when electronic system 900 is off. Some implementations of the subject disclosure use a mass-storage device (such as a magnetic or optical disk and its corresponding disk drive) as permanent storage device 902.

Other implementations use a removable storage device (such as a floppy disk, flash drive, and its corresponding disk drive) as permanent storage device 902. Like permanent storage device 902, system memory 904 is a read-and-write memory device. However, unlike storage device 902, system memory 904 is a volatile read-and-write memory, such a random access memory. System memory 904 stores some of the instructions and data that the processor needs at runtime. In some implementations, the processes of the subject disclosure are stored in system memory 904, permanent storage device 902, and/or ROM 910. For example, the various memory units include instructions for creating and providing opinion queries to users in a targeted manner in accordance with some implementations. From these various memory units, processing unit(s) 912 retrieves instructions to execute and data to process in order to execute the processes of some implementations.

Bus 908 also connects to input and output device interfaces 914 and 906. Input device interface 914 enables the user to communicate information and select commands to the electronic system. Input devices used with input device interface 914 include, for example, alphanumeric keyboards and pointing devices (also called “cursor control devices”). Output device interfaces 906 enables, for example, the display of images generated by the electronic system 900. Output devices used with output device interface 906 include, for example, printers and display devices, such as cathode ray tubes (CRT) or liquid crystal displays (LCD). Some implementations include devices such as a touchscreen that functions as both input and output devices.

Finally, as shown in FIG. 9, bus 908 also couples electronic system 900 to a network (not shown) through a network interface 916. In this manner, the computer can be a part of a network of computers (such as a local area network (“LAN”), a wide area network (“WAN”), or an Intranet, or a network of networks, such as the Internet. Any or all components of electronic system 900 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for execution on one or more computing devices for displaying an opinion query to a user, the method comprising:
receiving a request for online content from a user;
determining, using the one or more computing devices, one or more terms associated with the request;
selecting, using the one or more computing devices, an opinion query based on the one or more terms from a database coupled to the one or more processors, wherein the opinion query includes a question and one or more possible responses for the question;
providing the opinion query to be displayed to the user together with the online content corresponding to the request;
receiving an indication of a selection of one of the one or more possible responses from the user; and
providing, using the one or more computing devices, the indication of the selection for storage and analysis in association with the opinion query.

2. The method of claim 1, wherein the request for the online content comprises a request to search for the online content.

3. The method of claim 2, wherein the one or more terms comprise one or more search terms specified by the user.

4. The method of claim 1, further comprising:
identifying using the one or more computing devices the one or more terms according to the request.

5. The method of claim 1, wherein the database stores one or more promotional content items including one or more opinion queries, wherein each of the promotional content items is associated with one or more keywords.

6. The method of claim 1, wherein the selecting the opinion query comprises:
comparing using the one or more computing devices one or more keywords associated with the opinion query and the one or more terms; and
selecting the opinion query based on the comparing.

7. The method of claim 1, wherein the opinion query is associated with one or more audience targeting information, the audience targeting information comprising one or more of a location, a language or demographic information.

8. The method of claim 7, further comprising:
identifying user information associated with the user, the user information comprising one or more of a user location, a user language and user demographic information, wherein the selecting the opinion query further comprises selecting the opinion query based on the user information.

9. The method of claim 8, wherein selecting the opinion query comprises:
comparing using the one or more computing devices the identified user information and the audience target information associated with the opinion query; and
selecting the opinion query based on the comparing.

10. The method of claim 1, wherein the selecting the opinion query comprises:
identifying using the one or more computing devices one or more of the promotional content items including the opinion query according to the one or more terms, the one or more promotional content items being associated with bidding information, wherein the bidding information for the opinion query specifies a bid for each response received with respect to the opinion query; and
selecting the opinion query from the one or more of the promotional content items according to the bidding information of the opinion query.

11. A system for displaying an opinion query to a user, the system comprising:
one or more processors; and
a machine-readable medium comprising instructions stored therein, which when executed by the processors, cause the processors to perform operations comprising:
receiving an indication of a request from a user to view online content;
identifying one or more terms associated with the request in response to receiving the indication;
selecting an opinion query of one or more existing opinion queries based on the identified one or more terms, wherein the opinion query includes a question and one or more possible responses to the question;
providing the opinion query to be displayed to the user along with the online content corresponding to the request;
receiving an indication of a selection of one of the one or more possible responses from the user; and
providing the response for storage and analysis in association with the opinion query.

12. The system of claim 11, wherein the request for online content comprises a request to search for the online content, and wherein identifying one or more terms comprises identifying the search terms entered by the user for retrieving the online content.

13. The system of claim 11, the operations further comprising:
identifying one or more keywords associated with the opinion query, wherein the one or more keywords comprise terms or phrases that are expected to trigger the selection of the opinion query.

14. The system of claim 11, wherein the selecting the opinion query comprises:
comparing the one or more keywords associated with the opinion query and the identified one or more terms; and
selecting the opinion query in response to determining that at least one of the one or more keywords matches at least one of the one or more identified terms.

15. The system of claim 11, the operations further comprising:
identifying user information associated with the user, the user information comprising one or more of a user location, a user language and user demographic information, wherein the selecting the opinion query further comprises selecting the opinion query based on the user information.

16. The system of claim 15, the operations further comprising:
identifying one or more audience targeting information associated with the opinion query, the audience targeting information comprising one or more of a location, a language or demographic information.

17. The method of claim 16, wherein selecting the opinion query further comprises:
comparing the identified user information and the identified audience target information associated with the opinion query; and
selecting the opinion query based on the comparing.

18. A machine-readable medium comprising instructions stored therein, which when executed by a machine, cause the machine to perform operations comprising:
receiving one or more terms associated with a request for content from a user;
selecting one or more opinion queries in response to receiving the indication, each opinion query being associated with one or more keywords matching at least one of the one or more terms, wherein each of the one or more opinion queries includes a question and one or more possible responses to the question;
identifying user information associated with the user and comparing the user information and audience targeting information associated with the one or more opinion queries;
selecting an opinion query for display to the user based on the comparing;
receiving an indication of a selection of one of the one or more possible responses from the user; and
providing the response for storage and analysis in association with the opinion query.

19. The machine-readable medium of claim 18, the operations further comprising:
identifying one or more keywords associated with the opinion query, wherein the one or more keywords comprise terms or phrases that are expected to trigger the selection of the opinion query.

20. The machine-readable medium of claim 18, wherein the selecting the opinion query comprises:
comparing the one or more keywords associated with the opinion query and the one or more terms; and
selecting the opinion query in response to the comparing.
